(19) United States
(12) Patent Application Publication
(10) Pub. No.: US 2024/0119469 A1
(43) Pub. Date: Apr. 11, 2024

(54) DATA GENERATION SYSTEM, DATA GENERATION METHOD, AND DATA GENERATION PROGRAM

(71) Applicant: NEC Corporation, Minato-ku, Tokyo (JP)

(72) Inventor: Noritaka YAMASHITA, Tokyo (JP)

(73) Assignee: NEC Corporation, Minato-ku, Tokyo (JP)

(21) Appl. No.: 18/275,949

(22) PCT Filed: Feb. 24, 2021
(86) PCT No.: PCT/JP2021/006863

§ 371 Date: Aug. 4, 2023

(51) Int. Cl. G06Q 30/0201; G07C 5/00

(52) U.S. Cl. CPC G06Q 30/0201; G07C 5/008

(57) ABSTRACT

The feature extraction means 81 extracts a feature of data from at least one data of market data and test data. The data selection means 82 selects one or more other data containing a feature corresponding to the extracted feature of the one data. The complementary data calculating means 83 calculates complementary data that complements the market data or the test data from the one data and the selected other data. The integrated data generation means 84 generates integrated data that integrates the calculated complementary data with at least one or both of the market data and the test data.

### TECHNICAL FIELD

This invention relates to a data generation system, a data generation method, and a data generation program for generating new data by linking multiple data.

### BACKGROUND ART

With a spread of connected cars, it has become possible to collect a variety of data from mass-produced vehicles driving around town. These collected data are then used to provide services such as a traffic congestion forecasting, an automobile insurance, and a failure diagnosis. The collected data can also be used for vehicle design development and testing.

For example, Patent Literature 1 describes a predictive diagnostic device for diagnosing signs of equipment abnormality. The device described in Patent Literature 1 acquires speed, external environment, acceleration, GPS data, and other data using sensors mounted in an automobile. Driving data immediately after a shipment of an automobile is then used as so-called training data under normal conditions in the automobile.

Non-patent Literature 1 describes model-free analysis technology that can determine a state of a system with high accuracy by comparing features mechanically extracted from time-series data. In addition, Patent Literature 2 describes invariant analysis, which automatically extracts relationships among sensors based on machine learning from time-series data from multiple sensors.

### CITATION LIST

### Patent Literature

PL 1: Japanese Laid-Open Patent Publication No. 2016-146169
PL 2: International publication 2019/026193

### Non Patent Literature

NPL 1: YOSHINAGA Naoki, TOGAWA Ryosuke, AJIRO Yasuhiro, “Time-Series Data Model Free Analysis Technology,” NEC Technical Journal, Vol. 72, No. 1, October 2019.

### SUMMARY OF INVENTION

### Technical Problem

On the other hand, as vehicle functions become more sophisticated and refined, the number of patterns to be tested increases, and the number of defects that occur tends to increase accordingly. Therefore, it is desirable to be able to prepare data covering all test patterns.

Here, it is possible to obtain various types of data in various driving environments from mass-produced vehicles. However, sensors mounted in mass-produced vehicles are generally fewer in number and less accurate than those used in testing, in order to reduce costs. Therefore, the data obtained from mass-produced vehicles as they are may not be sufficiently usable as data during evaluation and testing due to their low accuracy. Therefore, it is not possible to conduct sufficient evaluation and testing by simply using so-called post-shipment data of automobiles, as in the method described in Patent Literature 1.

On the other hand, data obtained in testing during development is highly accurate because of accuracy and variety of sensor values. However, considering the development cost, the test period and the patterns that can be considered are limited, so the coverage of test patterns is not always sufficient in many cases.

Therefore, it is desirable to be able to generate highly accurate test data with low development costs and high coverage of test pattern.

Therefore, it is an exemplary object of the present invention to provide a data generation system, a data generation method, and a data generation program that can generate highly accurate test data with low development cost and high coverage of test pattern.

### Solution to Problem

A data generation system according to the present invention is a data generation system that generates new data using market data collected from mass-produced vehicle and test data used to test vehicle during development phase, and includes: a feature extraction means that extracts a feature of data from at least one data of the market data and the test data; a data selection means that selects one or more other data containing a feature corresponding to the extracted feature of the one data; a complementary data calculation means that calculates complementary data that complements the market data or the test data from the one data and the selected other data; and an integrated data generation means that generates integrated data that integrates the calculated complementary data with at least one or both of the market data and the test data.

A data generation method according to the present invention is a data generation method that generates new data using market data collected from mass-produced vehicle and test data used to test vehicle during development phase, and includes: extracting, by a computer, a feature of data from at least one data of the market data and the test data; selecting, by the computer, one or more other data containing a feature corresponding to the extracted feature of the one data; calculating by the computer, complementary data that complements the market data or test data from the one data and the selected other data; and generating by the computer, integrated data that integrates the calculated complementary data with at least one or both of the market data and the test data.

A data generation program according to the present invention is a data generation program which is applied to a computer that generates new data using market data collected from mass-produced vehicle and test data used to test vehicle during development phase, for causing the computer to execute: a feature extraction process of extracting a feature of data from at least one data of the market data and the test data; a data selection process of selecting one or more other data containing a feature corresponding to the extracted feature of the one data; a complementary data calculation process of calculating complementary data that complements the market data or the test data from the one data and the selected other data; and an integrated data generation process that generates integrated data that integrates the calculated complementary data with at least one or both of the market data and the test data.

### Advantageous Effects of Invention

According to the invention, highly accurate test data can be created with low development cost and high coverage of test pattern.

### BRIEF DESCRIPTION OF DRAWINGS

FIG. 1 It depicts a block diagram showing an example configuration of a data generation system according to the present invention.

FIG. 2 It depicts a flowchart showing an example of the operation of the data generation system.

FIG. 3 It depicts an explanatory diagram showing an example of training data.

FIG. 4 It depicts an explanatory diagram showing an example of market data.

FIG. 5 It depicts a block diagram showing an overview of the data generation system according to the present invention.

FIG. 6 It depicts a schematic block diagram showing a configuration of a computer for at least one exemplary embodiment.

### DESCRIPTION OF EMBODIMENTS

The following is a description of the exemplary embodiment of the invention with reference to the drawings.

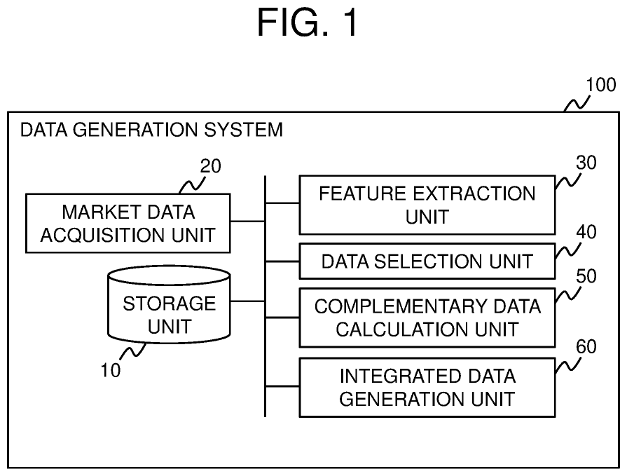

FIG. 1 is a block diagram showing an example configuration of a data generation system according to the present invention. The data generation system 100 of this exemplary embodiment includes a storage unit 10, a market data acquisition unit 20, a feature extraction unit 30, a data selection unit 40, a complementary data calculation unit 50, and an integrated data generation unit 60.

The storage unit 10 stores various information used by the data generation system 100 of this exemplary embodiment for processing. Specifically, the storage unit 10 stores data collected from mass-produced vehicles (hereinafter referred to as “market data”) and data used for vehicle testing in the development phase (hereinafter referred to as “test data”). The mass-produced vehicle is a vehicle that has completed the development phase and is mass-produced for sale in the market, and is actually operated and driven by consumers and others.

The nature of the market data and the test data differs greatly depending on the environment in which they are collected. First, in terms of data volume, the market data is data that is acquired from mass-produced vehicles, and therefore, a large amount of normal data can be collected. Compared to the normal data, the amount of defect data acquired from mass-produced vehicles is generally small. On the other hand, the test data is smaller in volume than the market data from the perspective of development costs (e.g., confirmed tests are not performed multiple times, etc.).

Next, in terms of data accuracy, the accuracy of test data is generally high because there are usually many types of sensors mounted on the vehicle and because the vehicle is in an environment where data can be collected reliably. The test data can also be created on the assumption for each test, such as for unit tests, coupling tests, and driving tests. On the other hand, the accuracy of the market data is generally lower than that of the test data because the types of sensors mounted in mass-produced vehicles are fewer than those used during development, and missing data is assumed depending on communication conditions.

Another feature of the market data is that a variety of data is collected from multiple mass-produced vehicles. In more detail, the market data includes telematics data sent from connected cars as data that is collected at all times, and DTC (Diagnostic Trouble Code) data extracted from ECUs (Engine Control Units) in the event of a breakdown as data that is collected at specific times.

Specifically, the driving data include time-series data of sensor values obtained from various vehicle components such as OBC (On-Board Charger)/CAN (Controller Area Network)−Bus, GPS (Global Positioning System) data, telematics data, etc. The video data includes images captured by a drive recorder (e.g., forward images).

In addition, from the driving data, it is possible to obtain information on the environment (e.g., weather information (typhoons, snow, etc.)) that is difficult to collect in the test environment.

In addition to data obtained as driving data, the failure data includes failure reports (failure part, contents, cause, and remedy) when the vehicle is brought to the dealer.

Depending on the specifications of the mass-produced vehicle, the acquired video images and the failure data may not necessarily be linked, but the video images and the driving data may be linked by mapping the video images to the driving data. One method of mapping video images to driving data includes tagging the video images.

On the other hand, a feature of the test data is that high number and accuracy of sensors used for testing, and it is easy to obtain driving conditions and other information during data acquisition. However, from a development cost perspective, it is difficult to cover all conditions with the test data due to limited time and resources. Furthermore, even if no problems occur in the test data for unit tests, problems may occur in coupling tests and driving tests from the viewpoint of coverage.

Specifically, the test data includes the same data as the driving data, and includes more items with higher accuracy than the market data. From the video data, it is possible to obtain not only from the forward video captured by the drive recorder, but also from the video captured by a multi-directional camera and the video inside the vehicle.

Furthermore, the test data is often created based on test specifications that are enriched in terms of test scenarios. Items included in the test specification (test data) include a version (model number), an individual number, an inspection target (single (part), combined (assembly), or integrated (vehicle)), an inspection perspective (functional/non-functional), preconditions (condition of other parts, driving environment, etc.), test procedures (control input, load input), expected results (normal/failure), judgment criteria (threshold, etc.), judgment results (OK/NG), and other items (judgment reasons, exceptions).

The storage unit 10 stores the market data acquired by the market data acquisition unit 20 described below. The storage unit 10 may store the market data acquired and created by other methods. The storage unit 10 also stores the test data created by designers and others.

The market data acquisition unit 20 acquires market data collected from mass-produced vehicles and stores it in the storage unit 10. The market data acquisition unit 20 may, for example, acquire driving data or video data transmitted from a connected car equipped with communication functions. The market data acquisition unit 20 may also improve the quality of the data by performing data cleansing on the acquired market data, for example, conversion to codes and deletion of outliers.

The feature extraction unit 30 extracts a feature of data from at least one data of the market data and the test data. In other words, the feature extraction unit 30 may extract a feature of the market data and may extract a feature of the test data.

The reason why the feature extraction unit 30 extracts a feature from the market data and the test data is explained here. The purpose of this invention is to generate more accurate data by taking advantage of the respective merits of the market data and the test data and using the other data to compensate for information lacking in one data.

On the other hand, it is difficult to simply integrate the market data and the test data because the items and the environment in which they were obtained are different between the market data and the test data. Therefore, in this exemplary embodiment, by focusing on the feature of the data itself and mapping data with matching or similar feature to each other, mutually lacking data is compensated for to create highly accurate data.

In the following explanation, for ease of understanding of the invention, the case in which the feature extraction unit 30 extracts feature of the market data from the market data is described. The following process can be similarly applied to the case where a feature is extracted from the test data.

Various methods can be used by the feature extraction unit 30 to extract the feature from the market data. For example, the feature extraction unit 30 may extract, from the market data, the data items themselves that represent the feature of the data. Such data items include an individual vehicle number, a vehicle model, etc. Otherwise, the feature extraction unit 30 may calculate correlations between data items that represent numerical data, such as speed and acceleration, and extract the correlations between such data items as the feature.

Furthermore, the feature extraction unit 30 may calculate a feature that synthesizes a relationship between values of each sensor mounted on the vehicle and time-series changes in the values of the sensors, and extract that feature as a feature of multiple data. The feature extraction unit 30 may calculate such a feature using, for example, the model-free analysis technology described in Non-patent Literature 1.

The method by which the feature extraction unit 30 extracts a feature from data is not limited to the above methods. For example, when the market data is log data, the feature extraction unit 30 may extract the pattern of the log itself as a feature. For example, when the market data is a group of sensor data, the feature extraction unit 30 may extract the relationships among past sensor data as a feature using the technology of invariant analysis as described in Patent Literature 2.

The data selection unit 40 selects one or more other data containing a feature corresponding to the extracted feature of the one data. For example, if a feature is extracted from the market data, the data selection unit 40 selects one or more test data that matches or is similar to the extracted feature. On the other hand, if the feature is extracted from the test data, the data selection unit 40 selects one or more market data that matches or is similar to the extracted feature.

The method by which data is selected by the data selection unit 40 is not limited, and the content of the method is arbitrary as long as the method enables selection of data with matching or similar feature. Specifically, the data selection unit 40 may predetermine items to be compared between the market data and the test data, and select data whose contents match or are within a predetermined range. For example, if the individual number, the vehicle model, and correlation values of numerical data as described above are defined as items to be compared, the data selection unit 40 may select data in which these items match or are similar.

Furthermore, there may be differences between the content of the market data acquired from aged mass-produced vehicles and data acquired from newer vehicles, depending on the degree of deterioration. Therefore, the data selection unit 40 may perform a predetermined weighting of the feature of the one data before comparing the features of the data.

More specifically, the data selection unit 40 may calculate a weight value according to the degree of deterioration (e.g., a weight value that changes the extracted feature more significantly the longer the driving distance or the longer the driving time) and select corresponding data by multiplying the calculated weight by the feature and comparing them. The method of calculating the weight values is arbitrary and may be predetermined according to the nature of the items. For example, the data selection unit 40 may determine that a weight of 0.8 is set for a certain feature of data obtained from a vehicle that has been running for 10 years, and so on.

For example, if a pattern in the logs described above is extracted as a feature, the data selection unit 40 may compare that pattern with the log of the market data or the log of the test data and select the corresponding data. Also, for example, if a relationship between past sensor data described above is extracted as a feature, the data selection unit 40 may compare that feature with the log of the market data or the log of the test data and select the corresponding data.

Otherwise, a correspondence table may be predetermined to determine that the items to be compared match or are similar, and the data selection unit 40 may select the data whose items to be compared are defined in the correspondence table. If a relationship between changes in time series is extracted as a feature, the data selection unit 40 may select multiple data corresponding to the feature.

Furthermore, the data selection unit 40 may narrow down the selection to the test data in similar situations to the acquired market data from among the selected test data. The test data similar situations include, for example, the test data with similar sensor values and the test data with similar forward-facing images. By narrowing down the selection to such the test data by the data selection unit 40, for example, if there is data that is not measured in the acquired market data but is included in the selected test data (e.g., backward-facing video), the data in the test data that is closer to the market data can be used as complementary data.

The complementary data calculation unit 50 calculates data that complements the market data or the test data (hereinafter referred to as “complementary data”) from the data whose features have been compared (one data) and the selected data (the other data).

The complementary data here includes not only data that complements missing data for items in either or both the market data and the test data, but also data that elaborates on data that already exists or new data generated to make the time interval between each data shorter.

The following explanation describes how the complementary data calculation unit 50 calculates the complementary data to complement the market data from the selected multiple test data. However, the following process can be applied in the same way when complementing the test data from the selected market data.

There are various modes to generate complementary data. The first is to complement the missing market data items with the test data. Specific examples are described below.

The first specific example is the method of complementing missing items in the market data with the test data of similar driving scenes. In this case, the data selection unit 40 selects the test data similar to the feature indicating driving scenes in the market data. The complementary data calculation unit 50 may then generate the complementary data by identifying the items missing in the market data and extracting the items from items of the selected test data that are closest to the missing items in the market data.

The complementary data calculation unit 50 may, for example, calculate the data to be complemented using the values before and after the test data collected in time series (e.g., by calculating the average value). Otherwise, the complementary data calculation unit 50 may calculate the data to be complemented using a method of missing completion such as the multiple assignment method. Furthermore, the complementary data calculation unit 50 may calculate the data to be complemented under the same conditions, for example, using data from parts with similar time, speed, data trends, etc. As described above, the complementary data calculation unit 50 may also generate the integrated data after complementing the data according to the degree of degradation, such as the distance traveled. These methods may be used in the same manner in the examples below.

Thus, the complementary data calculation unit 50 may calculate complementary data that complements the market data or the test data by extracting data for items missing from the one data (e.g., the market data) from the selected other data (e.g., the test data).

A second specific example is the method in which missing items in the market data are complemented based on other correlations (e.g., correlations of other sensors). In this case, the data selection unit 40 selects the test data similar to the feature extracted using technologies such as model-free analysis described above, for example. The complementary data calculation unit 50 may then generate complementary data that complements the missing items in the market data based on the correlations of the selected test data.

For example, when feature is extracted by the model-free analysis described above, the data selection unit 40 selects data including similar feature from the past test data. Then, the complementary data calculation unit 50 performs data extraction, data normalization, bias, and other processing on the detected data in accordance with the interval to be complemented, and calculates complementary data using the processed data.

For example, when feature is extracted by invariant analysis as described above, the data selection unit 40 selects data that are relevant to the data to be complemented. Then, the complementary data calculation unit 50 calculates the complementary data by predicting the data to be complemented from the selected data using relationship.

In the case of sensor failure, etc., the complementary data calculation unit 50 may generate complementary data by combining knowledge from the knowledge base.

The second mode is a mode of using the test data to improve the accuracy of the market data, for example, there is a method of generating integrated data at 0.1-second intervals using the test data from the market data collected at 1-second intervals. In this case, the data selection unit 40 may, for example, also select the test data similar to the feature indicating driving scenes in the market data, and the complementary data calculation unit 50 may generate new data using the selected test data to generate the time interval of each data shorter.

Thus, the complementary data calculation unit 50 may calculate the complementary data for at a time interval shorter than that at which the one data (e.g., the market data) was collected from the selected other data (e.g., the test data).

Furthermore, the complementary data calculation unit 50 may change the method of calculating complementary data according to a characteristic of the data to be used. For example, it is assumed that the characteristic of the data to be used are classified into normal condition data and abnormal condition data. Since it can be said that the abnormal condition data is more important than the normal condition data, the complementary data calculation unit 50 may calculate the complementary data for abnormal condition data in more detail than the complementary data for the normal condition data.

As a method for detailed calculation, the type of data to be calculated can be made to represent more detailed information (for example, normal condition data should be of type int and abnormal condition data should be of type double), the time interval of generated data can be made shorter (for example, normal condition data should be at intervals of 1 second and abnormal condition data at intervals of 0.1 second), and so on.

The integrated data generation unit 60 generates data that integrates the calculated complementary data with at least one or both of the market data and the test data (hereinafter referred to as “integrated data”).

For example, if missing items are calculated as complementary data, the integrated data generation unit 60 may generate the integrated data in which the missing parts are filled in by integrating the complementary data with the market data. Also, for example, if new data is generated as complementary data to make the time interval of each data shorter, the integrated data generation unit 60 may insert the generated data into the existing market data to generate the integrated data with shorter time intervals.

The market data acquisition unit 20, the feature extraction unit 30, the data selection unit 40, the complementary data calculation unit 50, and the integrated data generation unit 60 are realized by a computer processor (e.g., CPU (Central Processing Unit)) operating according to a program (data generation program).

For example, the program may be stored in the storage unit 10, and the processor may read the program and operate as the market data acquisition unit 20, the feature extraction unit 30, the data selection unit 40, the complementary data calculation unit 50, and the integrated data generation unit 60 according to the program. The functions of the data generation system 100 may be provided in a SaaS (Software as a Service) format.

The market data acquisition unit 20, the feature extraction unit 30, the data selection unit 40, the complementary data calculation unit 50, and the integrated data generation unit 60 may each be realized by dedicated hardware. Also, some or all of the components of each device may be realized by general-purpose or dedicated circuits (circuitry), processors, etc., or a combination thereof. They may be configured by a single chip or by multiple chips connected via a bus. Part or all of each component of each device may be realized by a combination of the above-mentioned circuits, etc. and a program.

When some or all of the components of the data generation system 100 are realized by multiple information processing devices, circuits, etc., the multiple information processing devices, circuits, etc. may be centrally located or distributed. For example, the information processing devices and circuits may be realized as a client-server system, a cloud computing system, or the like, each of which is connected via a communication network.

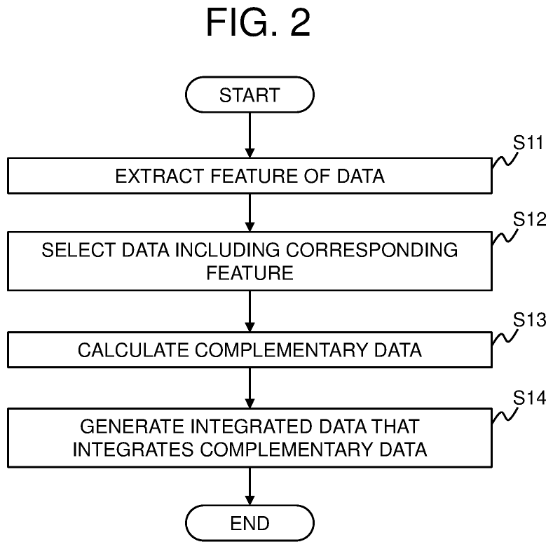

Next, the operation of this exemplary embodiment of the data generation system 100 will be described. FIG. 2 is a flowchart showing an example of the operation of the data generation system 100 of this exemplary embodiment. Here, it is assumed that the market data acquired by the market data acquisition unit 20 and the test data created by the designer and others are stored in the storage unit 10.

The feature extraction unit 30 extracts a feature of data from at least one of the market data and the test data (Step S11). The data selection unit 40 selects one or more data of other data including a feature that correspond to the feature of one data (Step S12). The complementary data calculation unit 50 calculates complementary data that complements the market data or the test data from the one data and the selected other data (Step S13). The integrated data generation unit 60 then generates integrated data that integrates the calculated complementary data with at least one or both of the market and the test data (Step S14).

As described above, in this exemplary embodiment, the feature extraction unit 30 extracts a feature of the data from at least one of the market data and the test data, and the data selection unit 40 selects one or more other data including feature corresponding to the feature of the one data. Then, the complementary data calculation unit 50 calculates complementary data that complements the market data or the test data from the one data and the selected other data, and the integrated data generation unit 60 generates integrated data that integrates the calculated complementary data with at least one or both of the market data and the test data. Thus, highly accurate test data can be generated with low development cost and high coverage of test patterns.

The specific operation of the data generation system of this exemplary embodiment is described below. First, as a precondition, the contents of the market data are checked by designers, etc., and the missing parts (e.g., none, missing time series data, etc.) are identified.

Next, an analysis device (not shown) analyzes a feature of the market data. The analysis device analyzes, for example, slope and average values of the data (e.g., the average of the slopes of the X and Y coordinates) and indexes these features. When the model-free analysis described above is used, the analysis device learns a feature extraction engine using accumulated training data. The analysis device then generates feature data in binary format from the learned data using the learned feature extraction engine. The generated feature data is stored in the storage unit 10.

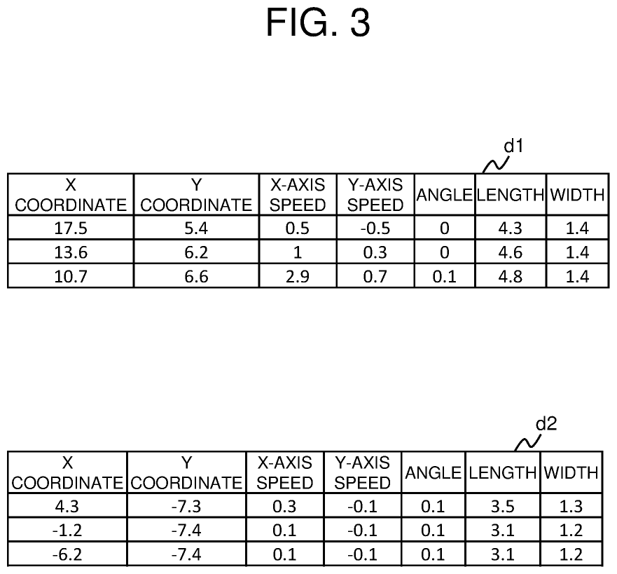

FIG. 3 is an explanatory diagram showing an example of training data. The data d1 and data d2 shown in FIG. 3 are part of the test data collected chronologically in a driving test. For example, when the model-free analysis technology is used, binary data named [0100] is generated as feature data from data d1, and binary data named [1001] is generated as feature data from data d2, and stored in the storage unit 10. This binary data is an example.

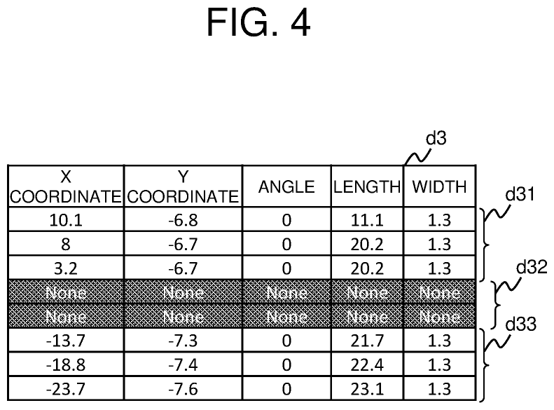

Next, the market data acquisition unit 20 receives the market data from the mass-produced vehicle and stores it in the storage unit 10. FIG. 4 is an explanatory diagram showing an example of the market data. The market data d3 shown in FIG. 4 is the one in which some data is missing for some reason and the data d32 is “None”. In addition, the market data shown in FIG. 4 does not include X-axis speed and Y-axis speed compared to the market data shown in FIG. 3.

The feature extraction unit 30 extracts a feature from the market data. The feature extraction unit 30 may calculate slope and average of the data as described above from the market data and extract them as a feature. The feature extraction unit 30 may also extract feature data in binary format from the market data shown in FIG. 4 using the feature extraction engine described above. For example, when the model-free analysis technology is used, the feature in the part of data d31 is converted to [0100] and the feature in the part of data d33 is converted to [1000].

The data selection unit 40 selects the test data to be used in the calculation of complementary data. Specifically, the data selection unit 40 matches the feature of the extracted market data with the feature of the test data and selects the test data with the highest similarity. For example, if the average of slope of the X coordinate and the average of slope of the Y coordinate of each test data are calculated as a feature, the data selection unit 40 may select the test data with the closest slope.

When the feature data of binary type described above has been generated, the data selection unit 40 may select the data in data d31 as the test data to be used for calculating the complementary data, since there is data matching the binary data [0100].

The complementary data calculation unit 50 calculates the complementary data. For example, the complementary data calculation unit 50 may select two points from the data d31 and use the data of the two selected points as-is as complementary data, or may calculate the average of the two points and use it as complementary data. The complementary data calculation unit 50 may also extract items (X-axis speed and Y-axis speed) that are not present in the market data from the test data and use them as complementary data. In this way, the complementary data calculation unit 50 may use data before and after the missing data in the market data and data at similar points in the test data to complement the market data.

The integrated data generation unit 60 then generates integrated data that integrates the calculated complementary data.

Next, application examples of the data generation system of this exemplary embodiment will be described. The first application example is an application example in which multiple test data matching the feature of the target market data are selected and complementary items are calculated. Specifically, when the market data acquisition unit 20 acquires the market data collected from mass-produced vehicles, the data selection unit 40 selects the multiple test data matching the feature extracted by the feature extraction unit 30.

The complementary data calculation unit 50 extracts data (e.g., slope, correlation, etc.) corresponding to the item to be complemented from the test data. The complementary data calculation unit 50 calculates the values to be complemented (e.g., mean, median, mode, etc.) from the extracted data. The integrated data generation unit 60 generates integrated data that integrates the calculated values into the market data.

A second application example is to increase data variation by selecting multiple market data for assumed situations. Here, it is assumed that multiple market data acquired by the market data acquisition unit 20 are stored in the storage unit 10.

The feature extraction unit 30 extracts a feature used to identify the specified situations. The data selection unit 40 selects the multiple market data that match the feature extracted by the feature extraction unit 30. The complementary data calculation unit 50 calculates data to be representative from the selected multiple market data. Methods for calculating the data to be representative include, for example, using statistical data such as the median, mean, mode, etc. of each item, or specifying the data randomly.

Then, the complementary data calculation unit 50 calculates values to be complemented, as in the first application example, in order to match the accuracy of the data to be representative with the accuracy of the test data, and the integrated data generation unit 60 generates the integrated data that integrates the calculated values with the market data.

A third application example is to make the market data more detailed (richer). For example, a sensor that was mounted in a vehicle during testing may be removed in a mass-produced vehicle to reduce costs. For example, a mass-produced vehicle may be equipped with sensors and a forward-facing camera for automatic driving. On the other hand, the vehicle under a test may be equipped with not only sensors and a forward-facing camera, but also a rear-facing camera for testing automatic driving.

Therefore, the integrated data generation unit 60 integrates some of the market data of similar situations into the data that is not included in the market data. In the example above, the integrated data generation unit 60 integrates the images from the rear-facing camera in the test data into the market vehicle data. This makes it easier to understand the driving conditions of the mass-produced vehicle and improves the accuracy of the analysis. For example, since the test data can be generated for simulations showing virtual surrounding conditions, this test data can be used as video for learning video analysis AI (Artificial Intelligence).

A fourth application example is to augment scenarios in test data. Specifically, a scenario that could not be executed with the test data can be pseudo-created using the market data. For example, by extracting the market data related to unexecuted test scenarios and constructing the test data, it is possible to create new test scenarios.

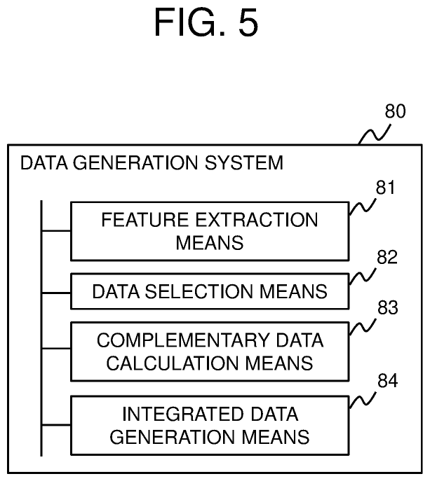

The following is an overview of the invention. FIG. 5 is a block diagram showing an overview of the data generation system according to the invention. The data generation system 80 according to the present invention is a data generation system (e.g., data generation system 100) that generates new data using market data collected from mass-produced vehicles and test data used to test a vehicle in the development stage, and that includes a feature extraction means 81 (e.g., feature extraction unit 30) that extracts a feature of data from at least one data of the market data and the test data, a data selection means 82 (e.g., data selection unit 40) that selects one or more other data (e.g., test data) including a feature corresponding to the extracted feature of the one data (e.g., market data), a complementary data calculating means 83 (e.g., complementary data calculating unit 50) that calculates complementary data that complements the market data or the test data from the one data and the selected other data, and an integrated data generation means 84 (e.g., complementary data calculating unit 60) that generates integrated data that integrates the calculated complementary data with at least one or both of the market data and the test data.

Such a configuration allows highly accurate test data to be generated with low development cost and high coverage of test patterns.

Specifically, the feature extraction means 81 may extract the feature of the market data from the market data, the data selection means 82 may select multiple test data corresponding to the feature of the extracted market data, the complementary data calculation means 83 may calculate complementary data that complements the market data from the selected multiple test data, and the integrated data generation means 84 may generate integrated data that integrates the calculated the data with the market data.

The data selection means 82 may further select test data for situations similar to the market data from the selected test data.

The feature extraction means 81 may also calculate a feature that synthesizes a relationship between values of each sensor mounted on the vehicle and time-series changes in the time values of the sensors, and extract the calculated feature as a feature of multiple data.

The data selection means 82 may also calculate weight value according to degree of degradation and select corresponding data by multiplying the calculated weights by the feature and comparing them.

The complementary data calculation means 83 may calculate complementary data that complements the market data or the test data by extracting data of items missing in the one data from the selected other data.

The complementary data calculation means 83 may also calculate, from the selected other data, complementary data for at a time interval shorter than that at which the one data was collected.

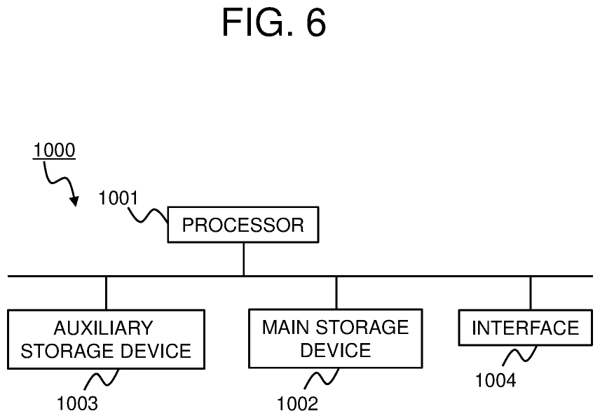

FIG. 6 is a schematic block diagram showing a configuration of a computer in at least one exemplary embodiment. A computer 1000 includes a processor 1001, a main storage device 1002, an auxiliary storage device 1003, and an interface 1004.

The data generation system 80 described above is implemented in the computer 1000. The operations of each of the above-mentioned processing parts are stored in the auxiliary storage device 1003 in the form of a program (data generation program). The processor 1001 reads the program from the auxiliary storage device 1003, loads the program in the main storage device 1002, and executes the above processing according to the program.

It is noted that, in at least one exemplary embodiment, the auxiliary storage device 1003 is an example of a non-transitory tangible medium. Other examples of the non-transitory tangible medium include a magnetic disk, a magneto-optical disk, CD-ROM (Compact Disc Read-only memory), DVD-ROM (Read-only memory), a semiconductor memory, etc., connected via the interface 1004. Furthermore, when the program is distributed to the computer 1000 via a communication line, the computer 1000 receiving the distribution may load the program in the main storage device 1002 and execute the above process.

Furthermore, the program may also be provided to implement a of the aforementioned functions. Furthermore, the program may be a so-called difference file (difference program), which implements the aforementioned functions in combination with other programs already stored in the auxiliary storage device 1003.

Some or all of the above exemplary embodiments may also be described as, but not limited to, the following Supplementary note.

(Supplementary note 1) A data generation system that generates new data using market data collected from mass-produced vehicle and test data used to test a vehicle during development phase, comprising: a feature extraction means that extracts a feature of data from at least one data of the market data and the test data; a data selection means that selects one or more other data including a feature corresponding to the extracted feature of the one data; a complementary data calculation means that calculates complementary data that complements the market data or the test data from the one data and the selected other data; and an integrated data generation means that generates integrated data that integrates the calculated complementary data with at least one or both of the market data and the test data.

(Supplementary note 2) The data generation system according to Supplementary note 1, wherein the feature extraction means extracts the feature of the market data from the market data, the data selecting means selects multiple test data corresponding to the feature of the extracted market data, the complementary data calculation means calculates complementary data that complements the market data from the selected multiple test data, and the integrated data generation means generates integrated data that integrates the calculated complementary data with the market data.

(Supplementary note 3) The data generation system according to Supplementary note 2, wherein the data selection means further selects test data for situations similar to the market data from the selected test data.

(Supplementary note 4) The data generation system according to any one of Supplementary note 1 to Supplementary note 3, wherein the feature extraction means calculates a feature that synthesizes a relationship between the values of each sensor mounted on the vehicle and the time-series changes in the values of the sensors, and extracts the calculated feature as a feature of multiple data.

(Supplementary note 5) The data generation system according to any one of Supplementary note 1 to Supplementary note 4, wherein the data selection means calculates weight value according to degree of deterioration and selects corresponding data by multiplying the calculated weights by the feature and comparing them.

(Supplementary note 6) The data generation system according to any one of Supplementary note 1 to Supplementary note 5, wherein the complementary data calculation means calculates complementary data that complements the market data or the test data by extracting data of items missing in the one data from the selected other data.

(Supplementary note 7) The data generation system according to any one of Supplementary note 1 to Supplementary note 6, wherein the complementary data calculation means calculates, from the selected other data, complementary data for at a time interval shorter than that at which the one data was collected.

(Supplementary note 8) A data generation method that generates new data using market data collected from mass-produced vehicle and test data used to test a vehicle during development phase, comprising: extracting, by a computer, a feature of data from at least one data of the market data and the test data; selecting, by the computer, one or more other data including a feature corresponding to the extracted feature of the one data; calculating by the computer, complementary data that complements the market data or the test data from the one data and the selected other data; and generating by the computer, integrated data that integrates the calculated complementary data with at least one or both of the market data and the test data.

(Supplementary note 9) The data generation method according to Supplementary note 8, further comprising: extracting, by the computer, the feature of the market data from the market data, selecting, by the computer, multiple test data corresponding to the feature of the extracted market data, calculating by the computer, complementary data that complements the market data from the selected multiple test data, and generating by the computer, integrated data that integrates the calculated complementary data with the market data.

(Supplementary note 10) A program storage medium for storing a data generation program which is applied to a computer that generates new data using market data collected from mass-produced vehicle and test data used to test a vehicle during development phase, for causing the computer to execute: a feature extraction process of extracting a feature of data from at least one data of the market data and the test data; a data selection process of selecting one or more other data including a feature corresponding to the extracted feature of the one data; a complementary data calculation process of calculating complementary data that complements the market data or the test data from the one data and the selected other data; and an integrated data generation process that generates integrated data that integrates the calculated complementary data with at least one or both of the market data and the test data.

(Supplementary note 11) The program storage medium for storing the data generation program according to Supplementary note 10, for causing the computer to further execute: extracting the feature of the market data from the market data in the feature extraction process; selecting multiple test data corresponding to the feature of the extracted market data in the data selecting process; calculating complementary data that complements the market data from the selected multiple test data in the complementary data calculation process, and generating integrated data that integrates the calculated complementary data with the market data in the integrated data generation process.

(Supplementary note 12) A data generation program which is applied to a computer that generates new data using market data collected from mass-produced vehicle and test data used to test a vehicle during development phase, for causing the computer to execute: a feature extraction process of extracting a feature of data from at least one data of the market data and the test data; a data selection process of selecting one or more other data including a feature corresponding to the extracted feature of the one data; a complementary data calculation process of calculating complementary data that complements the market data or the test data from the one data and the selected other data; and an integrated data generation process that generates integrated data that integrates the calculated complementary data with at least one or both of the market data and the test data.

(Supplementary note 13) The data generation program according to Supplementary note 12, for causing the computer to further execute: extracting the feature of the market data from the market data in the feature extraction process; selecting multiple test data corresponding to the feature of the extracted market data in the data selecting process; calculating complementary data that complements the market data from the selected multiple test data in the complementary data calculation process, and generating integrated data that integrates the calculated complementary data with the market data in the integrated data generation process.

The above description of the present invention is with reference to the exemplary embodiments, but the present invention is not limited to the above exemplary embodiments. Various changes can be made to the composition and details of the present invention that can be understood by those skilled in the art within the scope of the present invention.

### INDUSTRIAL APPLICABILITY

The invention is suitably applicable to a data generation system that generates new data by linking multiple data. Specifically, the invention can be applied to solutions using linked data. The solutions using the linked data include, for example, predictive failure detection, failure cause identification, degradation prediction, failure prediction, etc. It is also possible to contribute to the development of simulators by collecting data under various environments and generating data for simulators. In addition, by generating data based on aging data and failure data from market vehicles, it is possible to feed these data back to development.

### REFERENCE SIGNS LIST

10 Storage unit
20 Market data acquisition unit
30 Feature extraction unit
40 Data selection unit
50 Complementary data calculation unit
60 Integrated data generation unit
100 Data generation system

What is claimed is:

1. A data generation system that generates new data using market data collected from mass-produced vehicle and test data used to test a vehicle during development phase, comprising:
a memory storing instructions; and
one or more processors configured to execute the instructions to:
extract a feature of data from at least one data of the market data and the test data;
select one or more other data including a feature corresponding to the extracted feature of the one data;
calculate complementary data that complements the market data or the test data from the one data and the selected other data; and
generate integrated data that integrates the calculated complementary data with at least one or both of the market data and the test data.

2. The data generation system according to claim 1, wherein the processor is configured to execute the instructions to:
extract the feature of the market data from the market data-data;
select multiple test data corresponding to the feature of the extracted market data;
calculate complementary data that complements the market data from the selected multiple test data; and
generate integrated data that integrates the calculated complementary data with the market data.

3. The data generation system according to claim 2,
wherein the processor is configured to execute the instructions to further select test data for situations similar to the market data from the selected test data.

4. The data generation system according to claim 1,
wherein the processor is configured to execute the instructions to calculate a feature that synthesizes a relationship between values of each sensor mounted on the vehicle and time-series changes in the values of the sensors, and extract the calculated feature as a feature of multiple data.

5. The data generation system according to claim 1,
wherein the processor is configured to execute the instructions to calculate weight value according to degree of deterioration and select corresponding data by multiplying the calculated weights by the feature and comparing them.

6. The data generation system according to claim 1,
wherein the processor is configured to execute the instructions to calculate complementary data that complements the market data or the test data by extracting data of items missing in the one data from the selected other data.

7. The data generation system according to claim 1,
wherein the processor is configured to execute the instructions to calculate, from the selected other data, complementary data for at a time interval shorter than that at which the one data was collected.

8. A data generation method that generates new data using market data collected from mass-produced vehicle and test data used to test a vehicle during development phase, comprising:
extracting, by a computer, a feature of data from at least one data of the market data and the test data;
selecting, by the computer, one or more other data including a feature corresponding to the extracted feature of the one data;
calculating by the computer, complementary data that complements the market data or the test data from the one data and the selected other data; and
generating by the computer, integrated data that integrates the calculated complementary data with at least one or both of the market data and the test data.

9. The data generation method according to claim 8, further comprising:
extracting, by the computer, the feature of the market data from the market data,
selecting, by the computer, multiple test data corresponding to the feature of the extracted market data,
calculating by the computer, complementary data that complements the market data from the selected multiple test data, and
generating by the computer, integrated data that integrates the calculated complementary data with the market data.

10. A non-transitory computer readable information recording medium storing a data generation program which is applied to a computer that generates new data using market data collected from mass-produced vehicle and test data used to test a vehicle during development phase, when executed by a processor, the data generation program that performs a method for:
extracting a feature of data from at least one data of the market data and the test data;
selecting one or more other data including a feature corresponding to the extracted feature of the one data;
calculating complementary data that complements the market data or the test data from the one data and the selected other data; and
generating integrated data that integrates the calculated complementary data with at least one or both of the market data and the test data.

11. The non-transitory computer readable information recording medium for storing the data generation program according to claim 10, the data generation program that further performs a method for:
extracting the feature of the market data from the market data;
selecting multiple test data corresponding to the feature of the extracted market data;
calculating complementary data that complements the market data from the selected multiple test data; and
generating integrated data that integrates the calculated complementary data with the market data.
